(19) United States
(12) Patent Application Publication
(10) Pub. No.: US 2021/0131468 A1
(43) Pub. Date: May 6, 2021

(54) Knockdown Furniture Piece Assembly and Method

(71) Applicant: Venkataramu Bangalore, Plano, TX (US)

(72) Inventor: Venkataramu Bangalore, Plano, TX (US)

(73) Assignee: Noble House Home Furnishings, LLC, Chatsworth, CA (US)

(21) Appl. No.: 16/999,304

(22) Filed: Aug. 21, 2020

Related U.S. Application Data
(60) Provisional application No. 62/890,237, filed on Aug. 22, 2019.

(51) Int. Cl. F16B 12/06; A47B 3/06; A47C 4/02

(52) U.S. Cl. CPC F16B 12/06; A47C 4/028; A47C 4/021; A47B 3/06

(57) ABSTRACT

A furniture item comprises a first modular component, a second modular component, and third modular component. A first connector assembly is provided for connecting the first modular component with the second modular component. A second connector assembly is provided for connecting the first modular component or the second modular component with the third modular component, the first and second connector assemblies being different.

### CROSS REFERENCE TO RELATED APPLICATIONS

This application claims the benefit of U.S. Provisional Patent Application No. 62/890,237 filed Aug. 22, 2019, the contents of which are incorporated herein by reference in their entirety.

### FIELD AND BACKGROUND OF THE INVENTION

This invention relates to a knockdown furniture piece assembly and method therefor, wherein the furniture piece is comprised of a plurality of modules or components. In one form of the invention, the furniture piece comprises a side table, or it may be a form of seating, but the invention is not limited to such an item of furniture.

In one embodiment, the invention comprises a furniture piece assembly which may be in the form of a side table, which is manufactured as a series of separate modules or components, the separate modules and components being placed in a container in a compact configuration for later assembly by the end-user. Preferably, the furniture piece assembly comprises a plurality of connectors which are used in conjunction with the separate modules or components, and the modules and components together with the connectors are joined together so as to form the fully assembled furniture piece structure.

As noted above, the furniture piece assembly of the invention may comprise a side table. Side tables, as the name suggests, generally reside on the side of the room, adjacent a sofa or chair, or away from other furniture such as a main table, but may still be located near a sofa, chaise lounge, or other armchairs in the space, so that they can be accessible as well as readily utilized when needed. Often of slightly smaller size, these side tables may be more like an end table than a coffee table and are more than just decorative living room furniture pieces. They may also be used as an addition in bedrooms or home offices, to name some examples without limitation as to possible uses. Furthermore, a plurality of such side tables may be grouped together, in selected configurations, so as to create either permanently or temporarily a bigger useful surface, according to the changing needs of those using such space.

Many of the side tables and other furniture items currently available on the market will either be pre-assembled, or are sold with a multitude of components where some assembly by the end-user is needed. Those items requiring assembly will, of course, require the use of tools to effect the assembly, and these may be provided either as part of a kit which is packed with the furniture item, or the tools need to be supplied by the end-user. Additionally, for those items requiring assembly to some extent, a basic knowledge is preferred, which is not always present. Many end-users are often frustrated with complicated or poorly worded instructions and procedures. Such users would thus generally prefer the benefits of reduced costs associated with multiple part items and compact packing, but do not have the inclination, patience or ability to assemble the item on their own.

As regards preassembled versions of furniture, these are often bulky and packed in larger containers or wrapping, and as a consequence may be damaged during transport and handling. They may also be more expensive or inconvenient to store, transport and deliver.

One disadvantage with items which require assembly by the end-user is that fasteners or connectors may be small, sometimes difficult to distinguish (such as bolt sizes) and there may be many of them. As a result, they can be easily lost or misplaced either during the manufacturing and packing process where it is not unusual to miss or omit necessary hardware, or during transit or even the assembly thereof by the end-users. This may result in significant inconvenience and long delays for the end user.

### SUMMARY OF THE INVENTION

According to the aspect of the invention, there is provided a furniture item comprising: a first modular component; a second modular component; a third modular component; a first connector assembly for connecting the first modular component with the second modular component; and a second connector assembly for connecting the first modular component or the second modular component with the third modular component, the first and second connector assemblies being different.

Preferably, the first modular component and second modular component comprise a body portion of the furniture item, and the third modular component comprises a base or cover portion of the furniture item. Each of the first and second modular components may comprise a side edge having a flange, the first connector assembly connecting to the side edges and flanges of the first and second modular components to secure them to each other. In one embodiment, the first connector assembly comprises an elongate bracket for engaging the side edges of the first and second modular components.

The elongate bracket may be generally of a U-shape having a base wall and depending side walls defining a channel, the base wall and side walls engaging the flanges of the side edges so as to accommodate them within the channel of the elongate bracket. The elongate bracket may slide over the side edges and flange of the first and second modular components from one end of the side edge to another end of the side edge. In one form, the side walls of the elongate bracket further comprises a lip, the lip engaging with the flange on the side edge of the first and second modular components.

The furniture item may comprise a plurality of additional components connected to each other by a plurality of the first connector assembly to form a complete or partially complete furniture item, and the first modular component and the second modular component may be substantially the same. Further, a plurality of first connector assemblies may be provided to connect a single first modular component with an adjacent single second modular component.

In one aspect, the second connector assembly comprises a hook member on the third modular component and a correspondingly located recess in the first or second modular assembly, the hook member being releasably received within the recess. The hook member may comprise a projection having a first end attached to and extending outwardly from a surface of the third modular component and a second end in the form of a lip for attachment within the recess.

The recess may comprise a slotted aperture. In one embodiment, the slotted aperture of the recess comprises a wider portion and a narrower portion, wherein the wider portion is of sufficient size to permit the insertion and withdrawal of the hook member, and the narrower portion is sized so that the hook member when moved into the narrower portion is captured therein and cannot be withdrawn. The hook member may be movable from the wider portion of the slotted aperture to the narrower portion thereof by moving or rotating the hook member along an axis of the slotted member.

The first and second modular components preferably form at least a part of a body of the furniture item and the third component comprises a base or cover of the furniture item, with the recess being formed on the body and the hook member being formed on the base or cover.

According to another aspect of the invention, there is provided a method of making a furniture item comprising the steps of: providing a first modular component; locating a second modular component adjacent the first modular component and positioning it relative thereto for assembly of the first and second modular components to each other; providing a third modular component; connecting a first connector assembly to the first modular component and to the second modular component so as to connect the first and second modular components to each other; and connecting a second connector assembly to the first modular component or the second modular component and to the third modular component so as to connect at least one of the first or second modular component assemblies and the third modular assembly to each other, the first connector assembly and the second connector assembly being different from each other.

Preferably, a side edge having a flange is formed on each of the first and second modular components, the first connector assembly connecting to the side edges and flanges of the first and second modular components to secure them to each other. The first connector assembly may slide over the side edges and flange of the first and second modular components from one end of the side edge to another end of the side edge. A plurality of additional components may be connected to each other by a plurality of the first connector assembly to form a complete or partially complete furniture item.

According to yet a further aspect of the invention, there is provided a furniture item comprising: a first modular component having a side edge; a second modular component having a side edge; and a first connector assembly comprising an elongate bracket having side walls and a base wall defining a generally U-shaped channel space, the first connector assembly engaging the side edges of the first modular component and the second modular component for connecting the first modular component with the second modular component.

The present invention is one which therefore provides the end-user with a product, such as an item of furniture, for example a side table, which is delivered in a knockdown kit form. The invention may therefore comprise a multitude or plurality of components which need to be oriented relative to each other, and thereafter connected to form the assembled product. In accordance with the present invention, the knockdown furniture piece of the invention requires no tools to assemble, and does not utilize traditional fasteners, such as bolts, screws, spacers etc., which may be difficult to use for inexperienced or disinclined people, and which may be lost or misplaced. The absence of just one fastening component can make the difference between a completely assembled product and one which is incapable of being fully assembled, so that the potential inconvenience factor is significant.

The knockdown furniture piece assembly of the invention can be used in a wide spectrum of shapes and sizes, and for furniture and side tables of differing material. The furniture piece assembly can be also used as storage, a seat, a surface, or a combination of some or all of these.

According to one aspect of the invention, there is provided a furniture item comprised of a plurality of modules, wherein the modules are assembled and connected to each other without the need for tools or small hardware.

According to a further aspect of the invention, there is provided a furniture item comprised of a plurality of modules, and a plurality of connector pieces, the connector pieces extending between the modules so as to effect a firm and stable connection between the modules when the furniture item is in the assembled condition.

According to yet a further aspect of the invention, there is provided a method for assembling a furniture item comprised of a plurality of modules and connected pieces, the connector pieces being located between the modules to effect a firm and stable connection between the modules when the furniture item is in the assembled condition.

### BRIEF DESCRIPTION OF THE DRAWINGS

In the drawings:

FIG. 1 is a perspective view showing two modular components of a furniture item in the form of a side table and a connector for connecting the two modular components;

FIG. 2 is a detailed perspective view showing a slot along one or both of the upper lower edges of the furniture item;

FIG. 3 is a detailed perspective view showing a hook and tab structure formed on the lid of the furniture item and positioned so as to releasably engage with the slot illustrated in FIG. 2 of the drawings;

FIG. 4 is a perspective view showing two unassembled modules of a side table furniture item in accordance with the present invention;

FIG. 5 is a perspective view of the unassembled modules shown in FIG. 4, and a connector for securing the two modular components to each other;

FIG. 6 is a perspective view of the modules shown in FIG. 5, which have been joined together by means of the inserted connector;

FIG. 7 is a perspective view showing the addition of a third module which has been joined by a connector to a previously assembled module;

FIG. 8 is a perspective view showing the addition of a fourth module which has been joined by a connector to its two adjacent modules to form the completed sidewalls of the table in construction;

FIG. 9 shows a perspective view of the completed sidewalls shown in FIG. 8 and a base piece located or oriented in position for attachment thereto;

FIG. 10 shows a perspective view of the base piece affixed to the completed sidewalls using the slots and tab connection illustrated in FIGS. 2 and 3 of the drawings;

FIG. 11 shows a perspective view of the completed sidewalls and attached base piece shown in FIG. 10, turned around upside down to illustrate the open top end;

FIG. 12 shows a perspective view of the assembled side wall and base piece with a lid positioned or oriented for attachment to the upper surface of the sidewalls;

FIG. 13 shows a perspective view of the assembled modular furniture item with the connected side walls, the connected base piece, and the connected lid;

FIGS. 14 and 15 show different perspective views of the finally assembled furniture item in accordance with the invention; and

FIG. 16 is a detailed view of a connector piece used in accordance with one embodiment of the invention.

### DETAILED DESCRIPTION OF THE INVENTION

Reference is now made to the accompanying drawings, which show one preferred embodiment of a furniture item in accordance with the present invention.

The drawings illustrate the invention insofar as it relates to a side table or side table with storage area, but the invention is not limited to an item of furniture of this type. The modular components and connectors for joining the modular components can in fact be used in many different types of furniture, and it will be understood that these other types of furniture are covered by and fall within the scope of the invention as described and illustrated herein.

The figures and drawings in this patent application exemplify the invention with reference to a side table or similar piece of furniture, but can generally be used for the assembly of other items of furniture as well. The drawings are not, therefore, to be considered as limiting in any way the scope of the different types of furniture with which the invention may be used, provided such types of furniture utilize the connecting mechanisms and structures and methods described herein.

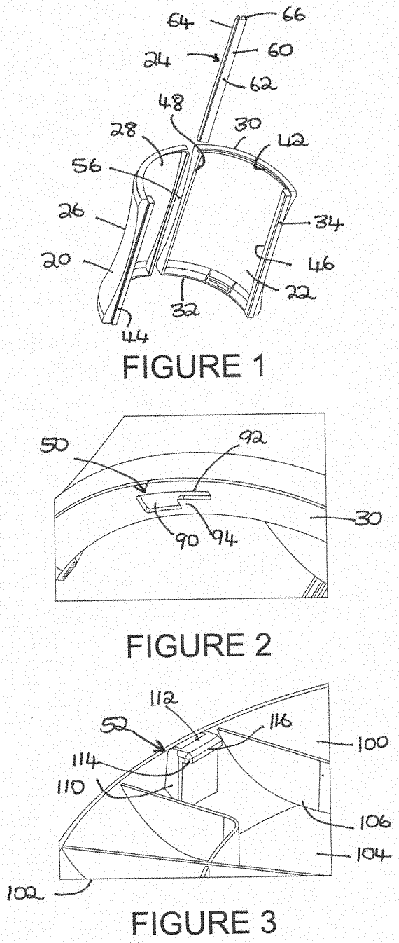

FIG. 1 of the drawings shows two of four side panels 20 and 22, each of the side panels 20 and 22 being curved so as to form approximately one quarter of a circle, and a connector piece 24. Each of the side panels 20 and 22 has an outer surface 26, an inner surface 28, an upper edge 30, a lower edge 32, and a pair of opposing side edges 34 and 36. Two of the four side panels 20 and 22 as illustrated in FIG. 1 are shown oriented with respect to each other so that opposing side panels 20 and 22 are adjacent to each other.

Each of the side panels 20 and 22 further comprises an upper flange 42 at its upper edge 30, a lower flange 44 at its lower edge 32, and a pair of inwardly extending flanges 46 and 48 on each of the opposing side edges 34 and 36. As will be described further below, both the upper flange 42 and the lower flange 44 have formed therein slots 50, details of which will be described further below, each of the slots 50 being capable of receiving and accommodating a tab or post 52 which is formed on a base piece and a lid piece, also illustrated and to be described below.

The unattached connector piece 24 as shown in FIG. 1 of the drawings is positioned above the space 56 between the first and second side panels 20 and 22, and is configured so as to attach these first and second side panels 20 and 22 to each other, preferably in a releasable manner so that convenient disassembly of the item can be achieved at a later stage, if desired. FIG. 1 of the drawings also shows positionally the connector 24 ready for installation or connecting of the first and second side panels 20 and 24, above and to the side of each of the first and second side panels 20 and 24, and opposite to those side edges 34 and 36 that the unattached connector 24 shown in this figure will attach. In other words, the first and second side panels 20 and 22, and the connector 24, are positioned relative to each other in a ready-to-assemble orientation.

In the present embodiment, the connector 24 comprises a generally U-shaped, and elongate structure, the length which corresponds approximately to the length of the side edges 34 and 36 of the side panels 20 and 22. While a single connector 24 is shown for connecting together the side edges 34 and 36 of adjacent side panels 20 and 22, it will be appreciated that the connector 24 may be smaller, or shorter in length, and extend over a lesser distance, and there may be several of such connectors 24 extending over the length of the side panels 20 and 22, each covering a partial length of the side edges 34 and 36, in order to effect a secure connection between the side panels. Whether one or more connectors 24 is used will be determined by the dimensions of the item of furniture, the load it must support in use, the other parameters, so that an optimal construction and strength of the item of furniture can be achieved in any particular situation.

Each connector 24 is, as mentioned above, generally U-shaped, defining a channel or slot 60 which extends along its length. The U-shaped structure includes a base 62 and sidewalls 64 and 66 defining the channel 60, and the sidewalls 64 and 66 at their ends remote from the base may have inwardly extending ledges 70. A space or opening 72 is present between the ends of these opposing ledges 70, thereby providing access to the channel or slot 60.

A pair of adjacent side panels 20 and 22 are arranged side-by-side such that the inwardly extending flange 46 of one side panel 22 abuts against the inwardly extending flange 48 of its adjacent side panel 20. The two inwardly extending flanges 46 and 48, when touching each other, have a width which is snugly accommodated within the channel or slot 60 of the connector 24. As the connector 24 slides down over the pair of inwardly extending flanges 46 and 48 which are adjacent to each other, a connection between the two is established, thus connecting the one side panel 20 with its adjacent side panel 22. The inwardly extending ledges 70 on the connector 24 may, in certain embodiments of the invention, comprise a rail which may slide in a recess provided on the side panel, and such rail may preferably be formed on the inwardly extending flanges. This embodiment may provide additional strength and resilience to the connection established in situations where greater stability to support a load, for example, may be needed.

Once fully inserted, the connector 24 will not extend above the upper edge of the side panel or the lower edge of the side panel, and would preferably be substantially flush with the surfaces of the upper edge 30 and the lower edge 32 respectively. The connector 24 could also be shorter than the length or height of the side panels 20 and 22, such as extending over the middle section of the side panels 20 and 22, or near the ends thereof, only.

It will be seen that FIG. 1 of the drawings shows connectors 24 on the other sides of the side panels 20 and 22, ready for connection with yet another side panel. It will be appreciated that the connector 24 may be inserted over both of the inwardly extending flanges 46 and 48 of adjacent side panels 20 and 22, when placed together, or, the connector 24 may slide over a single inwardly extending flange 46 or 48 into position, and the adjacent side panel thereafter inserted by sliding its inwardly extending flange 48 or 46 downwardly (or upwardly) through the slot or channel 60 of the connector 24. In other words, the invention is not limited to the order or sequence in which the modules and connector pieces may be connected to each other.

In the manner described above, four side panels 20, 22, 80 and 82 are assembled without the use of any tools, simply by arranging these side panels relative to each other in the correct orientation, and using the connector 24 portion of the invention to join or fasten together these panels or modules. Assembly is therefore efficient and very simple, requiring no tools or hardware such as bolts, nuts, screws, washers and the like. Conversely, the furniture item may be just as easily disassembled without the use of any tools by simply removing or disengaging the connectors 24. Until the side panels 20, 22, 80 and 82 have been joined together, they can be compactly packed in the container by nestling within each other, saving space and bulk.

FIG. 2 of the drawings shows one of a series of slots 50 which are arranged on the upper edge 30 and the lower edge 32 of each of the side panels 20 and 22. Each of the slots 50 follows the radial arc of the side panel 20 or 22. If, however, the panels to be connected are more linear, appropriate adjustments and changes can be effected. The slot 50 comprises a wider portion 90 and a narrower portion 92, each communicating with each other. The narrower portion 92 will thus comprise a slot 50 portion coupled with a shelf 94, such slot 50 portion and shelf 94 having a width which is substantially the same as the wider portion 90 of the slot 50.

FIG. 3 of the drawings shows a lid or base 100 of the furniture item, and which can be connected to the assembled side panels 20 and 22 and 80 and 82, as described above. The lid and base 100 both have an outer surface 102, and an inner surface 104 which may include ribs 106 or other structure for providing additional strength and resiliency thereto. At designated positions along the inner surface 104 of each of the lid and base 100, there is a depending post 52. Each depending post 52 has a body portion 110 connected at one end to the lid or base 100, and a snap piece 112 at the other end thereof. The snap piece 112 comprises an inwardly projecting portion 114 with a chamfered edge or end 116. The depending post 52 cooperates with and attaches to the slots 50 shown in FIG. 2 of the drawings. Thus, during assembly, the lid or base 100 are aligned with the assembled side panels 20, 22, 80 and 82 so that the depending post 52 is positioned over the wider portion 90 of the slot 50. The depending post 52 is then inserted to the wider portion 90 of the slot 50, following upon which the lid or base 100 is slightly rotated so as to move the depending post 52 from the wider portion 90 of the slot 50 to the narrower portion 92 of the slot 50. At this juncture, the inwardly projecting portion 114 engages with a shelf 94 in a manner such that the lid or base 100 respectively will become attached to the side panels through this connection.

It should be appreciated that the lid or base 100 can be easily removed simply by slightly rotating in the opposite direction so that the depending post 52 is able to be removed from the slot 50 at the wider portion 90 thereof. Disassembly is therefore relatively easily achieved.

The connection of the lid or base 100 to the side panel 22 using the configured slots 50 and the depending posts 52 allows for assembly in a simple and effective manner without the use of any tools or supplementary hardware. Even when disassembled, there are no separated parts or tools to be lost or broken, and the connecting structures are and remain integral with the item of furniture itself. Therefore, if disassembled and stored or transported, there is little likelihood of losing any tools or connecting hardware which may be needed for later reassembly of the furniture item. The forms of connection are for the most part integrated components of the furniture item itself, making loss of tools and hardware impossible. Further, the connector 24 itself, although able to be separated from the modules, can in fact remain securely connected to one of the modules during storage as further assurance that it will not become misplaced or lost.

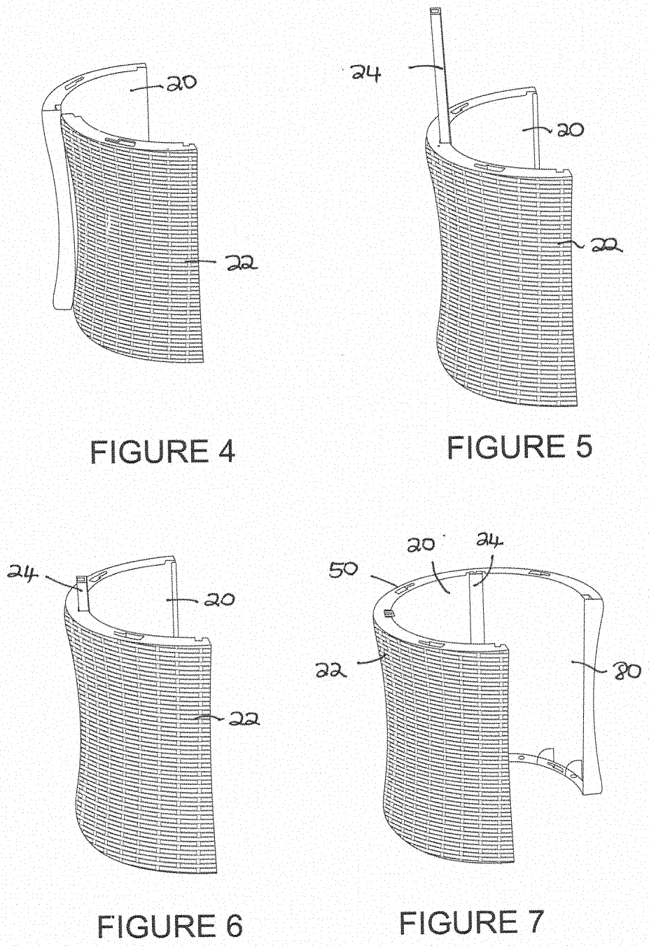

FIGS. 4 to 8 of the drawings show sequential assembly steps for an item of furniture, such as a side table or storage unit as illustrated, from the knockdown or delivered condition. FIG. 4 shows two quadrants of a round side table, namely, modular sidewalls 20 and 22, being placed adjacent to each other with side edges 34 and 36 facing each other. In FIG. 5 of the drawings, the connector 24 is inserted in the respective hardware of the modular sidewalls to embrace the inwardly extending flanges 46 and 48 on the modules 20 and 22, firmly joining the modules together in a stable and secure manner. FIG. 6 of the drawings shows the connector 24 mostly but not completely inserted, before the last few inches thereof is inserted to engage with the inwardly extending flanges 46 and 48.

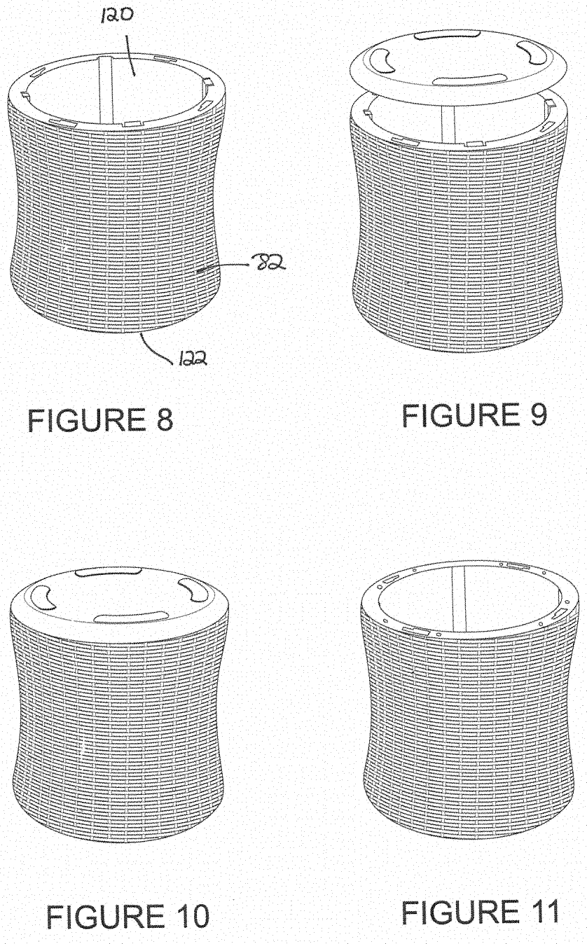

In FIG. 7 of the drawings, a third quadrant 80 comprising an additional side wall 80 is added, once again by using a connector 24 using a track in rail assembly type connection which is inserted in the corresponding portions of the two adjacent side panels to effectively join them, as described above. In FIG. 8 of the drawings, the fourth quadrant side panel 82 is installed and connected using the connector part 24, thereby forming solid continuous sidewalls in a tubular or cylindrical configuration comprising the furniture item. Both the upper end 120 and the lower end 122 are open, but may be thereafter closed and sealed, in a preferably releasable fashion, by the installation of a base and lid 100 respectively, as illustrated sequentially in FIGS. 9 to 13 of the drawings.

In FIG. 9 of the drawings, the base piece 100A is oriented over the lower open end 122 of the sidewalls, such that the depending posts 52 located on the base 100A are placed over the slots 50 formed in the lower edge 32 of the side panels 20 and others. The base piece 100A is then lowered until each of the depending posts 52 on the inside 104 of the base piece 100A enters the wider portion 90 of the slot 50. Once so located, the base piece 100A is rotated about its center axis by a small amount until such time as the depending posts 52 are moved into the narrower portion 92 of the slot 50. When in this location, the inwardly projecting component 114 of the depending post 52 portion engages the shelf 94 adjacent the narrower slot 92, securing the base piece 100A to the assembled sidewalls. Preferably, four slots 50 are provided for receiving the depending posts 52, but the number of such slots 50 may vary according to the nature of the furniture item. Larger heavier pieces may require additional slots 50 for a firmer and more stable connection while, conversely, small items may require fewer points of connection. FIG. 10 of the drawings shows the base piece 100A installed on the assembled sidewalls.

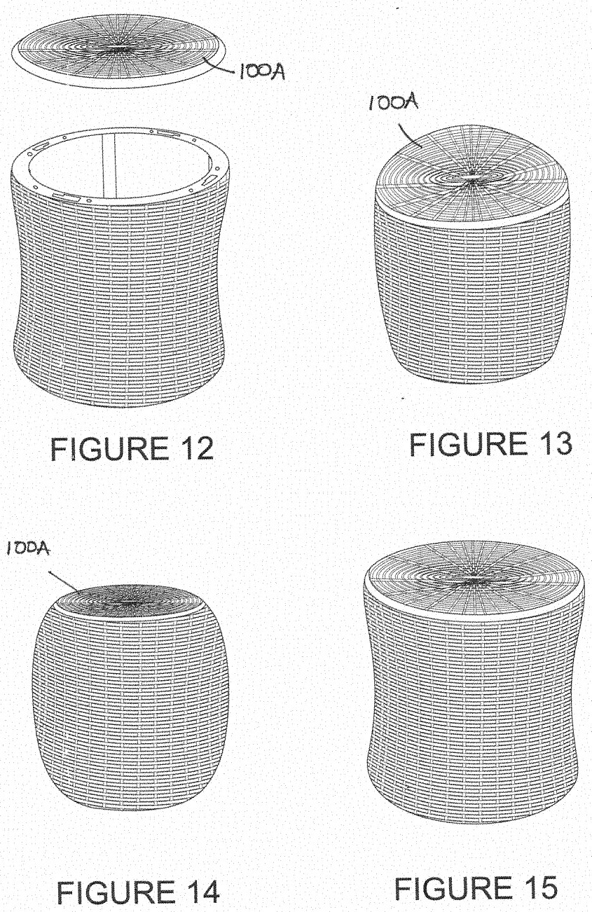

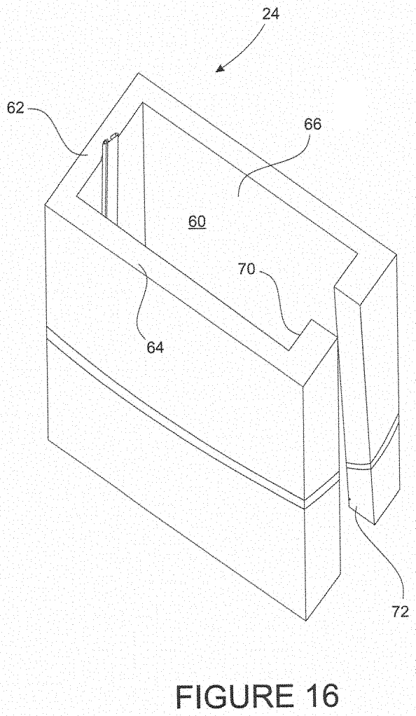

In FIG. 11, the sidewalls with base piece 100A attached is rotated with the base piece 100A resting on the floor or substrate, so that the lid 100B may be installed. As seen in FIG. 12, and as described with reference to the base piece 100A, the upper surface 42 of the side walls 20 and 22 have slots 50 as previously described, and the lower or inner surface 104 of the lid 100B has depending posts 52 and inwardly projecting ledges 114, both of which engage with each other to effect a solid connection, as described above with respect to the base 100A. If the lid 100B is intended to be easily removed, it may comprise a handle or handles to provide a better grip to the user, and there may be fewer slots 50 and depending posts 52 so that a less tight configuration for connection is established, thereby making it easier for the user to remove and replace the lid 100B. In this way, the furniture item illustrated may have an interior space or chamber 130 which can be used for easily accessible, but visually hidden, storage. Dividers or shelves may be placed within the storage area 130, for improved storage capabilities.

FIGS. 13, 14 and 15 of the drawings illustrate a fully assembled furniture piece in accordance with the invention. A solid and stable structure is formed, and there is no hardware such as screws, bolts, nuts, washers and the like which have been used in the assembly. Further, no tools are required to either assemble the product or disassemble it when needed, since the generally integrated form of connection between the modules and connectors will mostly obviate the need for these parts. Thus, the knockdown product when manufactured or disassembled by the user may therefore be compactly contained within a container, with parts easily removed and assembled without the need for tools or additional hardware. This facilitates more efficient storage and transportation of the product, giving it environmental and convenience characteristics.

The drawings and description above are shown with reference to a side table or storage container or seat. However, it will be appreciated that the invention may apply to other types and categories of furniture where components may be assembled with respect to each other using the principles and structures as described herein.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A furniture item comprising:
a first modular component;
a second modular component;
a third modular component;
a first connector assembly for connecting the first modular component with the second modular component;
a second connector assembly for connecting the first modular component or the second modular component with the third modular component, the first and second connector assemblies being different.

2. A furniture item as claimed in claim 1 wherein the first modular component and second modular component comprise a body portion of the furniture item.

3. A furniture item as claimed in claim 1 wherein the third modular component comprises a base or cover portion of the furniture item.

4. A furniture item as claimed in claim 1 wherein each of the first and second modular components comprises a side edge having a flange, the first connector assembly connecting to the side edges and flanges of the first and second modular components to secure them to each other.

5. A furniture item as claimed in claim 4 wherein the first connector assembly comprises an elongate bracket for engaging the side edges of the first and second modular components.

6. A furniture assembly as claimed in claim 5 wherein the elongate bracket is generally of a U-shape having a base wall and depending side walls defining a channel, the base wall and side walls engaging the flanges of the side edges so as to accommodate them within the channel of the elongate bracket.

7. A furniture item as claimed in claim 6 wherein the elongate bracket slides over the side edges and flange of the first and second modular components from one end of the side edge to another end of the side edge.

8. A furniture item as claimed in claim 7 wherein the side walls of the elongate bracket further comprises a lip, the lip engaging with the flange on the side edge of the first and second modular components.

9. A furniture item as claimed in claim 1 comprising a plurality of additional components connected to each other by a plurality of the first connector assembly to form a complete or partially complete furniture item.

10. A furniture item as claimed in claim 1 wherein the first modular component and the second modular component are substantially the same.

11. A furniture item as claimed in claim 1 wherein a plurality of first connector assemblies are provided to connect a single first modular component with an adjacent single second modular component.

12. A furniture item as claimed in claim 1 wherein the second connector assembly comprises a hook member on the third modular component and a correspondingly located recess in the first or second modular assembly, the hook member being releasably received within the recess.

13. A furniture item as claimed in claim 1 wherein the second connector assembly comprises a hook member on the first or second modular component and a correspondingly located recess in the third modular assembly, the hook member being releasably received within the recess.

14. A furniture item as claimed in claim 12 wherein the hook member comprises a projection having a first end attached to and extending outwardly from a surface of the third modular component and a second end in the form of a lip for attachment within the recess.

15. A furniture item as claimed in claim 12 wherein the recess comprises a slotted aperture.

16. A furniture item as claimed in claim 15 wherein the slotted aperture of the recess comprises a wider portion and a narrower portion, wherein the wider portion of the slotted aperture is of sufficient size to permit the insertion and withdrawal of the hook member, and the narrower portion of the slotted aperture is sized so that the hook member when moved into the narrower portion is captured therein and cannot be withdrawn.

17. A furniture item as claimed in claim 16 wherein the hook member is movable from the wider portion of the slotted aperture to the narrower portion thereof by moving or rotating the hook member along an axis of the slotted member.

18. A furniture item as claimed in claim 12 wherein the first and second modular components form at least a part of a body of the furniture item and the third component comprises a base or cover of the furniture item, the recess being formed on the body and the hook member being formed on the base or cover.

19. A method of making a furniture item comprising the steps of:
providing a first modular component;
locating a second modular component adjacent the first modular component and positioning it relative thereto for assembly of the first and second modular components to each other;
providing a third modular component;
connecting a first connector assembly to the first modular component and to the second modular component so as to connect the first and second modular components to each other;
connecting a second connector assembly to the first modular component or the second modular component and to the third modular component so as to connect at least one of the first or second modular component assemblies and the third modular assembly to each other, the first connector assembly and the second connector assembly being different from each other.

20. A method as claimed in claim 19 wherein a side edge having a flange is formed on each of the first and second modular components, the first connector assembly connecting to the side edges and flanges of the first and second modular components to secure them to each other.

21. A method as claimed in claim 20 further comprising sliding a bracket of the first connector assembly over the side edges and flange of the first and second modular components from one end of the side edge to another end of the side edge.

22. A method as claimed in claim 21 comprising adding a plurality of additional components connected to each other by a plurality of the first connector assembly to form a complete or partially complete furniture item.

23. A method as claimed in claim 22 wherein the second connector assembly is formed as a hook member on the third modular component and a correspondingly located recess in the first or second modular assembly, the hook member being releasably received within the recess.

24. A method as claimed in claim 23 wherein the recess is formed as a slotted aperture.

25. A method as claimed in claim 24 wherein the slotted aperture of the recess comprises a wider portion and a narrower portion, wherein the wider portion of the slotted aperture is of sufficient size to permit the insertion and withdrawal of the hook member, and the narrower portion of the slotted aperture is sized so that the hook member when moved into the narrower portion is captured therein and cannot be withdrawn.

26. A method as claimed in claim 25 further comprising moving the hook member from the wider portion of the slotted aperture to the narrower portion thereof by rotating the hook member along an axis of the slotted member.

27. A furniture item comprising:
a first modular component having a side edge;
a second modular component having a side edge;
a first connector assembly comprising an elongate bracket having side walls and a base wall defining a generally U-shaped channel space, the first connector assembly engaging the side edges of the first modular component and the second modular component for connecting the first modular component with the second modular component.
